(19) United States
(12) Patent Application Publication
(10) Pub. No.: US 2024/0319968 A1
(43) Pub. Date: Sep. 26, 2024

(54) GENERATION OF AUTOMATIC ROBOTIC PROCESS AUTOMATION (RPA) BY MASS COLLABORATION ON BLOCKCHAIN

(71) Applicant: INTERNATIONAL BUSINESS MACHINES CORPORATION, Armonk, NY (US)

(72) Inventors: Logan BAILEY, Atlanta, GA (US); Zachary A. SILVERSTEIN, Georgetown, TX (US); Taylor SEGELL, Atlanta, GA (US); Jeremy R. FOX, Georgetown, TX (US)

(21) Appl. No.: 18/126,028

(22) Filed: Mar. 24, 2023

(51) Int. Cl. G06F 8/30; G06F 16/23

(52) U.S. Cl. CPC G06F 8/31; G06F 16/2379

(57) ABSTRACT

Aspects of the present disclosure relate generally to robotic process automation (RPA) and, more particularly, to systems, computer program products, and methods of automation of generating RPA by mass collaboration of RPA development on a distributed ledger blockchain. For example, a computer-implemented method includes: generating, by a processor set, from an RPA script a generic RPA script retaining functional information without business data; recording, by the processor set, the generic RPA script in a distributed ledger blockchain; obtaining, by the processor set, contextual information of the generic RPA script including uniform resource locator, query parameters, and post parameters; and recording, by the processor set, the contextual information of the generic RPA script in the distributed ledger blockchain.

### BACKGROUND

Aspects of the present invention relate generally to robotic process automation (RPA) and, more particularly, to systems, computer program products, and methods of automation of generating RPA by mass collaboration of RPA development on a distributed ledger blockchain.

Deployment of robotic process automation projects have accelerated across many organizations to perform a variety of tasks done manually. RPA code is typically expressed in human-readable language of one or more keywords and a command or programmed actions that perform steps of a specified requirement in a process document. In the development process, RPA code written as keywords and programmed actions may be stored in a repository such as one of several libraries used in an integrated development environment. Several developers may code RPA robots (bots) in working on the same or different projects for deployment on a website of an organization.

### SUMMARY

In a first aspect of the invention, there is a computer-implemented method including: generating, by a processor set, from an RPA script a generic RPA script retaining functional information without business data; recording, by the processor set, the generic RPA script in a distributed ledger blockchain; obtaining, by the processor set, contextual information of the generic RPA script including uniform resource locator, query parameters, and post parameters; and recording, by the processor set, the contextual information of the generic RPA script in the distributed ledger blockchain.

In another aspect of the invention, there is a computer program product including one or more computer readable storage media having program instructions collectively stored on the one or more computer readable storage media. The program instructions are executable to: download a generic RPA script referencing a page of a website from a distributed ledger blockchain to a client device; upload modifications of the generic RPA script from the client device to the distributed ledger blockchain; and store the generic RPA script with the modifications as a new version in the distributed ledger blockchain.

In another aspect of the invention, there is a system including a processor set, one or more computer readable storage media, and program instructions collectively stored on the one or more computer readable storage media. The program instructions are executable to: monitor website page automation of a plurality of generic RPA scripts in a distributed ledger blockchain; aggregate RPA interfacing patterns with a page of a website for interactions of the plurality of generic RPA scripts with the website; save the aggregated generic RPA interfacing patterns with the page of the website in persistent storage; and send a prompt to a client device of a frequent interfacing pattern with the page of the website for interaction with the website.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 depicts an illustration of an exemplary process flow in accordance with aspects of the present invention.

FIG. 4 shows a flowchart of an exemplary method in accordance with aspects of the present invention.

FIG. 5 shows a flowchart of an exemplary method in accordance with aspects of the present invention.

FIG. 6 shows a flowchart of an exemplary method in accordance with aspects of the present invention.

### DETAILED DESCRIPTION

Aspects of the present invention relate generally to robotic process automation (RPA) and, more particularly, to systems, computer program products, and methods of automation of generating RPA by mass collaboration of RPA development on a distributed ledger blockchain. More specifically, aspects of the present invention relate to methods, computer program products, and systems for receiving an RPA script from an integrated development environment (IDE) executing on a client device as a developer is automating pages of a website, monitoring the RPA script as the pages of the website are successfully automated in the RPA script, generating from the RPA script a generic RPA script retaining functional information without business data, recording the generic RPA script in a distributed ledger blockchain as the pages of the website are successfully automated, and recording functional contextual integration data for the generic script in the distributed ledger blockchain. In order to reuse existing RPA code developed for performing a specific task, the RPA developer needs to find the code that meets the requirements for performing the specific task. Locating such reusable RPA code can be a cumbersome experience with varying results for many developers given limited tools available in an integrated development environment to do so. According to aspects of the present invention, the methods, systems, and computer program products described herein automatically find generic RPA scripts that interact with the root page of the website stored in the distributed ledger blockchain as a developer is automating pages of the website and download one or more of the generic RPA scripts from the distributed ledger blockchain to the developer's IDE on the client device. Advantageously, the developer may select, use and/or modify the generic RPA scripts presented in the IDE on the client device.

In embodiments, the methods, systems, and program products described herein receive an RPA script from an integrated development environment (IDE) executing on a client device as pages of a website are automated, parse the RPA code format that includes in embodiments removing working data, such as business data, and generate a generic RPA script retaining functional information. The functional information may include in embodiments, for instance, variable names used, control ID, selector used, and configuration metadata, among other functional data. The methods, systems, and program products of the present disclosure record the generic RPA script in a distributed ledger blockchain and record functional contextual integration data for the generic RPA script in the distributed ledger blockchain. The functional contextual integration data may include in embodiments, for instance, uniform resource locator (URL), query parameters, and post parameters, among other functional data such as variable names used, control ID, selector used, and configuration metadata.

According to aspects of the present invention, the methods, systems, and computer program products further monitor website page automation of RPA scripts in the distributed ledger blockchain and begin processing transactions in aggregate to understand the pathway to implementation of the RPA script with pages of the website. The methods, systems, and program products of the present disclosure can send a prompt to a client device to notify a developer of more frequent patterns of interfacing with pages of the website. Furthermore, the methods, systems, and program products of the present disclosure can aggregate executions tracked on client devices to detect failure of an RPA script interacting with a page of a website that trigger a blockchain query for implementation pathway or process flow updates that may be used to modify the RPA script for successful RPA integration with the page.

Aspects of the present invention are directed to improvements in computer-related technology and existing technological processes for automation of generating RPA robots, among other features as described herein. In embodiments, the methods, computer program products, and systems may comprise receiving an RPA script from an IDE executing on a client device as pages of a website are automated, monitoring the RPA script as the pages of the website are successfully automated in the RPA script, generating from the RPA script a generic RPA script retaining functional information without business data, recording the generic RPA script in a distributed ledger blockchain as the pages of the website are successfully automated, and recording functional contextual integration data for the generic script in the distributed ledger blockchain. Advantageously, the methods, computer program products, and systems described herein automatically find generic RPA scripts that interact with the root page of the website stored in the distributed ledger blockchain as pages of a website are automated and download one or more of the generic RPA scripts from the distributed ledger blockchain to the developer's IDE on the client device so that the developer may select, use and/or modify the generic RPA scripts presented in the IDE on the client device. These are specific improvements in computer-related technology, existing technological processes, and in the way computers may operate and interoperate to automatically generate RPA scripts by mass collaboration of RPA development on a distributed ledger blockchain.

Implementations of the disclosure describe additional elements that are specific improvements in the way computers may operate and these additional elements provide non-abstract improvements to computer functionality and capabilities. As an example, the methods, computer program products, and systems describe an automatic RPA development module, RPA parser module, RPA instrumentation module, bot monitor module, RPA script downloader and uploader module, and bots analysis module that monitor website page automation of RPA scripts in a distributed ledger blockchain, aggregate RPA interfacing patterns with the page of the website for interactions of generic RPA scripts with the website, save the aggregated generic RPA interfacing patterns with the page of the website in persistent storage, and send a prompt to a client device to notify a developer of more frequent patterns of interfacing with pages of the website. The additional elements of the methods, computer program products, and systems of the present invention are specific improvements in the way computers may operate to automatically generate RPA scripts by mass collaboration of RPA development on a distributed ledger blockchain.

It should be understood that, to the extent implementations of the invention collect, store, or employ personal information provided by, or obtained from, individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as generation of automatic RPA by mass collaboration on blockchain code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

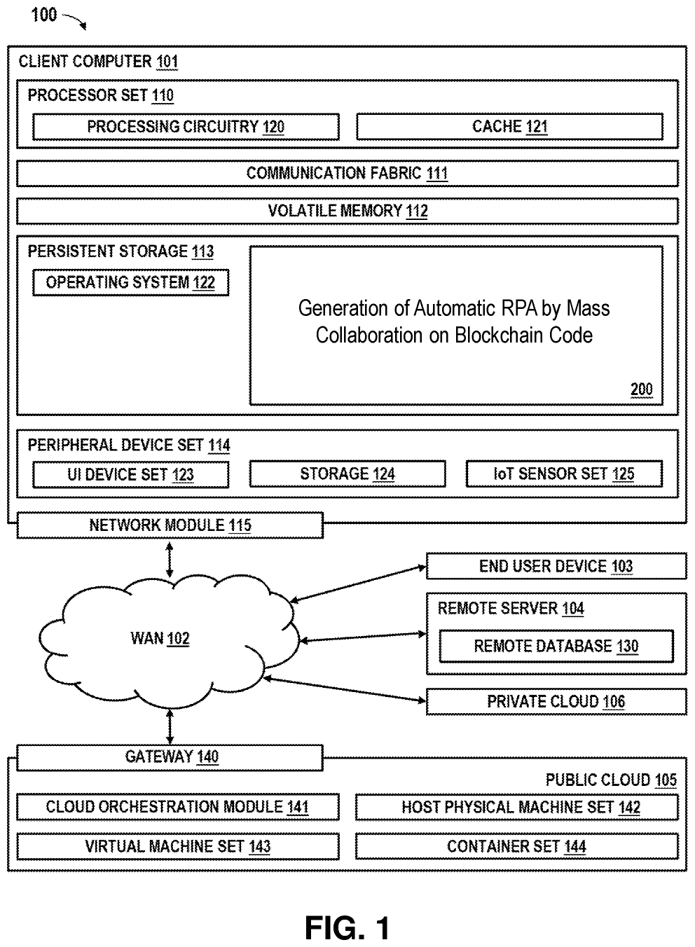

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

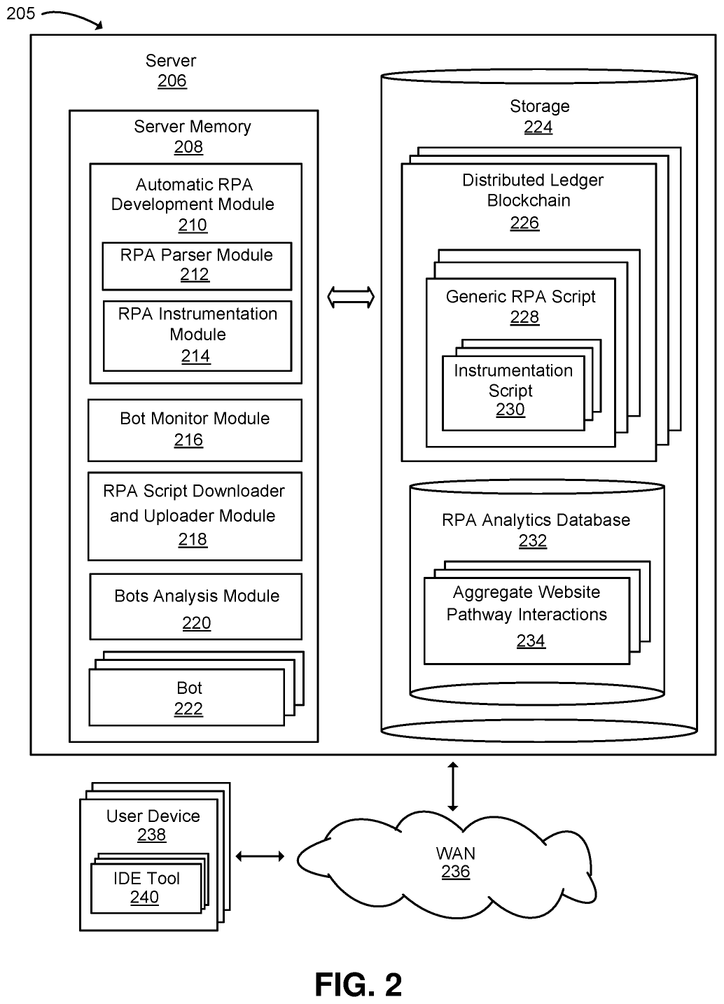

FIG. 2 shows a block diagram of an exemplary environment 205 in accordance with aspects of the present invention. In embodiments, the environment includes a server 206, which may be a computer system such as a computer 101 described with respect to FIG. 1 with which end user devices 103 and remote servers 104, each also described with respect to FIG. 1, may communicate over a network such as WAN 102 described with respect to FIG. 1. In general, server 206 supports services for automatic generation of RPA by mass collaboration of RPA development on a distributed ledger blockchain.

Server 206 has server memory 208 such as volatile memory 112 described with respect to FIG. 1. Server 206 includes, in memory 208, automatic RPA development module 210 having functionality to receive an RPA script, instrument the RPA script to provide execution and functional contextual information, generate a generic RPA script by removing working data and retaining functional data, record the generic RPA script in a distributed ledger blockchain, and record the execution and functional contextual information in the distributed ledger blockchain. The automatic RPA development module 210 may include in embodiments RPA parser module 212 having functionality to parse the RPA script format, remove working data, and retain functional information. The automatic RPA development module 210 may include in embodiments RPA instrumentation module 214 having functionality to instrument the RPA script to provide execution and functional contextual information for analysis.

Server 206 also includes, in memory 208, bot monitor module 216 having functionality in embodiments to monitor the development of the RPA script and execution of the bot. For example, the RPA script may be instrumented to provide the execution pathway and contextual information of the bot to the bot monitor module 216. Accordingly, the bot monitor module 216 receives information in embodiments as the website pages are successfully automated. In particular, the instrumented execution instance of the bot generates functional contextual information such as the web page uniform resource locator (URL), query parameters and POST parameters, and other information as the bot executes on an implementation pathway of the website. The bot monitor module 216 stores the contextual and execution information in RPA analytics database 232.

Server 206 further includes, in memory 208, RPA script downloader and uploader module 218 having functionality to download and upload RPA scripts stored in the distributed ledger blockchain. For example, the RPA script downloader and uploader module 218 can download generic RPA script command components used on a website upon detection of a developer on the root page of that website from the distributed ledger blockchain. The RPA script downloader and uploader module 218, as a further example, uploads modifications of generic RPA script commands for recordation to the distributed ledger blockchain that may be necessitated by global updates of pages to the website.

Server 206 also includes, in memory 208, bots analysis module 220 and one or more bots 222. Bots analysis module 220 has functionality that analyzes and aggregates contextual and execution information stored in RPA analytics database 232 of bots recorded in the distributed ledger blockchain. For example, execution information may include the execution pathway of the bot through pages of a website or multiple websites. The execution pathways of bots through pages of the website or multiple websites may be aggregated and stored in RPA analytics database 232.

In embodiments, the RPA development module 210, RPA parser module 212, RPA instrumentation module 214, bot monitor module 216, RPA script downloader and uploader module 218, bots analysis module 220 and bot 222, each may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The server 206 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the present invention, FIG. 2 also shows a block diagram of storage 224 which may be storage such as storage 124 of computer 101 described with respect to FIG. 1. Storage 224 may store distributed ledger blockchain 226 in files that record one or more generic RPA scripts 228 in embodiments which may include instrumentation scripts 230. For example, generic RPA script 228 is an RPA script that retains functional data such as variable names used, control ID, selector used, and configuration metadata among other functional data, but does not include working data such as business data. The generic RPA script 228 may be instrumented with one or more instrumentation scripts 230 that provide execution and functional contextual information for analysis. For instance, the execution information may include the execution pathway of the bot through pages of a website or multiple websites, and the functional contextual information may include the web page uniform resource locator (URL), query parameters, and POST parameters, among other information as the bot executes on an implementation pathway of the website.

Storage 224 may also store RPA analytics database 232 that may include, for example, bot execution information, contextual information, aggregated bot execution information, aggregated bot contextual information, and aggregated website pathway interactions 234 by bots interacting with one or more websites. The aggregated website pathway interactions represent the number of interactions by bots stored in distributed ledger blockchain 226 following a certain ordered pathway of pages of the website during interactions. High counts of aggregated website pathway interactions by bots indicate frequently used patterns by bots to interface with pages of the website. Thus, aggregated website pathway interactions can provide an understanding of pathways of implementation for developers creating new bots that interact with the website.

In accordance with aspects of the invention, the environment 205 of FIG. 2 also shows user device 238 which may be a computer system such as end user device 103, described with respect to FIG. 1, that may communicate over WAN 236 which may be a wide area network such as WAN 102, described with respect to FIG. 1. User device 238 may include integrated development environment (IDE) tools 240 that provide a software development environment among other software development tools for a software developer. The IDE tools 240 may be used to generate RPA script or code which may be any programming language source code including Java, JavaScript, Python, C++, C#, Visual Basic, SQL, PHP, or other programming language. RPA script may be written in various file formats, such as templates or scripts, using different integrated development environment tools that are built into deployable images and deployed in environment 205 of FIG. 2.

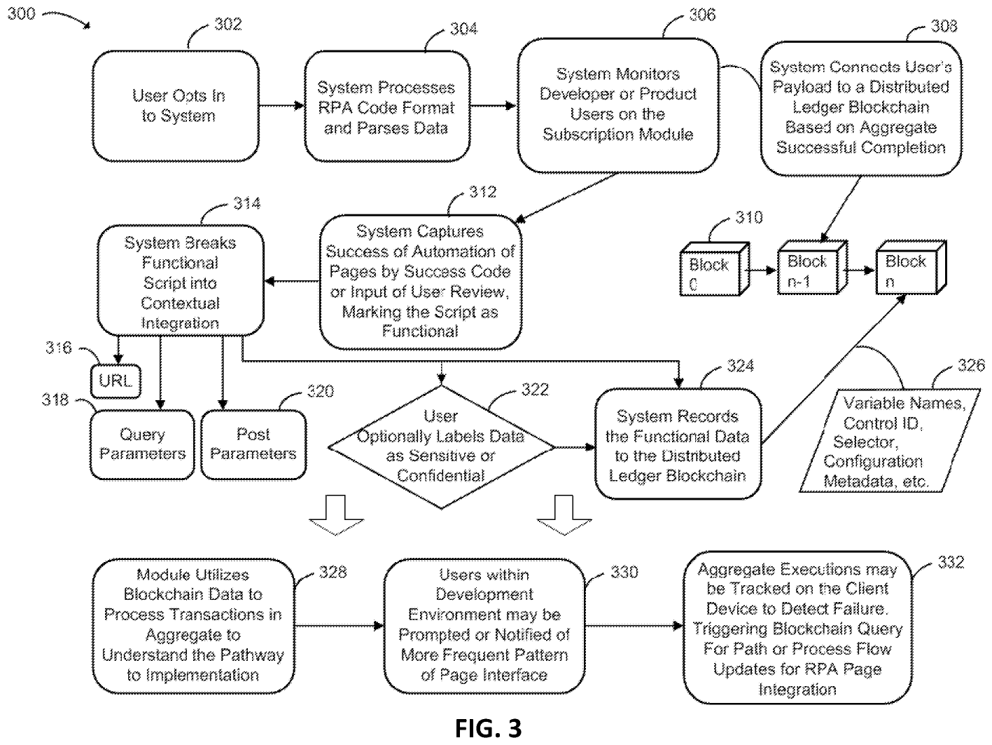

FIG. 3 depicts an illustration of an exemplary process flow in accordance with aspects of the present invention. In particular, the process flow diagram of FIG. 3 illustrates the process flow environment 300 in embodiments to automatically generate RPA by mass collaboration of RPA development on a distributed ledger blockchain. At reference numeral 302, the user of the system, for instance the RPA developer, opts in to use the exemplary modules of the system, such as automatic RPA development module 210, RPA parser module 212, RPA instrumentation module 214, bot monitor module 216, RPA script downloader and uploader module 218, and bots analysis module 220, each described with respect to FIG. 2, accessed in an integrated development environment (IDE). The system processes RPA code format and parses data at 304 that includes in embodiments removing working data such as business data, and retaining functional data such as variable names used, control ID, selector used, and configuration metadata, among other functional data to generate a generic RPA script. The RPA script may further be instrumented to collect execution and functional contextual information for analysis.

The system monitors the developer or product users of the RPA script at reference numeral 306 as the pages of the website are successfully automated in the RPA script. The system records the generic RPA script at 308 to a distributed ledger blockchain 310 based on aggregate successful completion as the pages of the website are successfully automated. The system captures the success of automation of the pages at 312 by success code or input of user review and marks the script as functional. At reference numeral 314, the system parses the functional script to obtain functional contextual integration data including URL 316, query parameters 318, and post parameters 320, among other functional data. Optionally, the user may label data as sensitive or confidential at 322. The system records the functional contextual integration data obtained at 314 and other functional data in the distributed ledger blockchain 310, including the functional data depicted at reference numeral 326 of variable names used, control ID, selector used, and configuration metadata.

When the generic RPA script and the functional data are recorded in the distributed ledger blockchain 310, the system may monitor website page automation of RPA scripts in the distributed ledger blockchain and begin processing transactions in aggregate to understand the pathway to implementation at 328 of the RPA script with pages of the website. Users within the development environment, such as environment 205 described with respect to FIG. 2, may be prompted or notified of more frequent patterns of interfacing with pages of the website at 330. Furthermore, aggregate executions may be tracked on the client device to detect failure at 332 of the RPA script interacting with a page of the website that trigger a blockchain query for implementation pathway or process flow updates that may be used to modify the RPA script for successful RPA integration with the page.

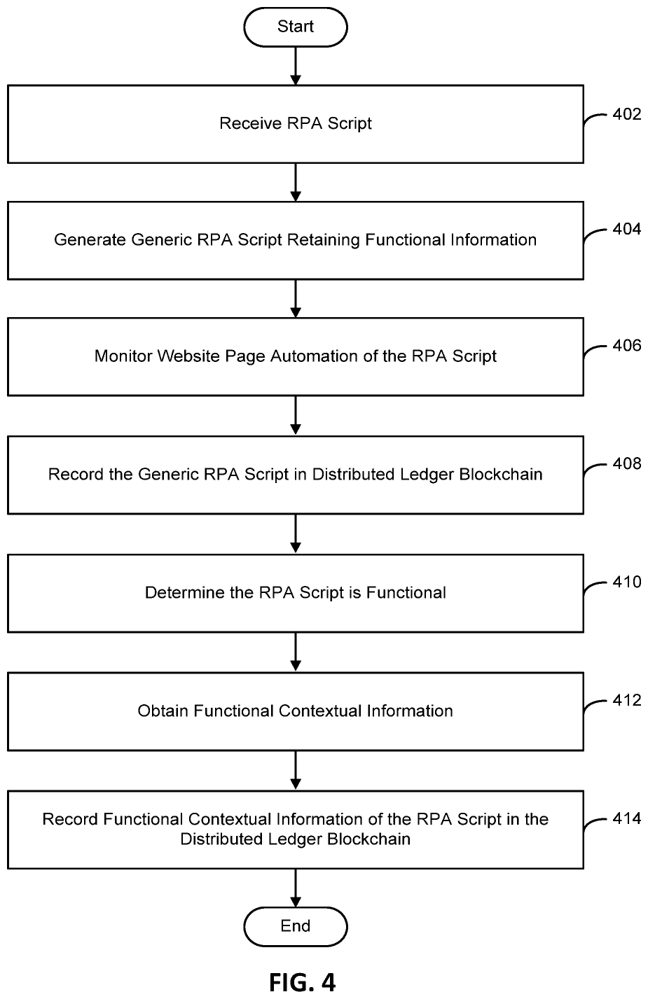

FIGS. 4-6 show flowcharts and/or block diagrams that illustrate the architecture, functionality, and operation of possible implementations of systems, methods, and computer program products according to various embodiments of the present invention. As noted above with respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time. And some blocks shown may be performed and other blocks not performed, depending upon the functionality involved.

FIG. 4 shows a flowchart of an exemplary method in accordance with aspects of the present invention. Steps of the method may be carried out in the environment of FIG. 2 and are described with reference to elements depicted in FIG. 2. In particular, the flowchart of FIG. 4 shows an exemplary method for automatic recording of RPA scripts in a shared distributed ledger blockchain in accordance with aspects of the present invention.

At step 402, the system receives an RPA script including any commands with accompanying parameters. For example, the RPA developer can opt in to use the exemplary modules of the system in an integrated development environment (IDE) executing on a client device and, as the developer writes the RPA script, the IDE executing on the client device can incrementally send the RPA script to the system. In embodiments, and as described with respect to FIG. 2, automatic RPA development module 210 receives the RPA script including any commands with accompanying parameters.

At step 404, the system generates a generic RPA script retaining functional information without business information. For example, the system processes the RPA script by parsing the RPA code format of the RPA script in embodiments, removing working data such as business data, and retaining functional data such as variable names used, control ID, selector used, and configuration metadata, among other functional data. In embodiments, the RPA script may further be instrumented to collect execution and functional contextual information for analysis. For instance, the execution information may include the execution pathway of the bot through pages of a website or multiple websites, and the functional contextual information may include the web page uniform resource locator (URL), query parameters, and POST parameters, among other information. In embodiments, and as described with respect to FIG. 2, automatic RPA development module 210 generates the generic RPA script retaining functional information without business information. As described with respect to FIG. 2, the automatic RPA development module 210 may include in embodiments RPA parser module 212 that parses the RPA script format, removes working data, and retains functional information, and the automatic RPA development module 210 may include in embodiments RPA instrumentation module 214 that instruments the RPA script to provide execution and functional contextual information for analysis.

At step 406, the system monitors the website page automation of the RPA script. For example, the system captures the success of automation of the pages by success code or input of user review as the pages of the website are successfully automated in the RPA script. The RPA script may be instrumented in embodiments to provide the execution pathway and contextual information of the bot, for example, to the bot monitor module 216 as described with respect to FIG. 2. Accordingly, the bot monitor module 216 receives information in embodiments as the website pages are successfully automated. In embodiments, and as described with respect to FIG. 2, bot monitor module 216 monitors the website page automation of the RPA script.

At step 408, the system records the generic RPA script in the distributed ledger blockchain as successful automation of pages of the website are completed. For example, the system records the generic RPA script in embodiments in the distributed ledger blockchain based on aggregate successful completion as the pages of the website are successfully automated. In embodiments, and as described with respect to FIG. 2, automatic RPA development module 210 records the generic RPA script in the distributed ledger blockchain 226 as it completes successful automation of pages of the website.

At step 410, the system determines the RPA script is functional. For example, the system captures the success of automation of the pages by success code or input of user review as the pages of the website are successfully automated in the RPA script. Upon completion of the automation of pages of the website, the system marks the script as functional. In embodiments, and as described with respect to FIG. 2, bot monitor module 216 determines the RPA script is functional.

At step 412, the system obtains functional contextual information. For instance, the system parses the generic RPA script to obtain functional contextual integration data including URL, query parameters, and post parameters, among other functional data. In embodiments, and as described with respect to FIG. 2, automatic RPA development module 210 obtains functional contextual information and includes in embodiments RPA parser module 212 that parses the generic RPA script to obtain functional contextual integration.

At step 414, the system records the functional contextual information of the generic RPA script in the distributed ledger blockchain. In embodiments, and as described with respect to FIG. 2, automatic RPA development module 210 records the functional contextual information of the generic RPA script in the distributed ledger blockchain 226. The system may monitor website page automation of RPA scripts in the distributed ledger blockchain and begin processing transactions in aggregate to understand the pathway to implementation of RPA scripts with pages of the website.

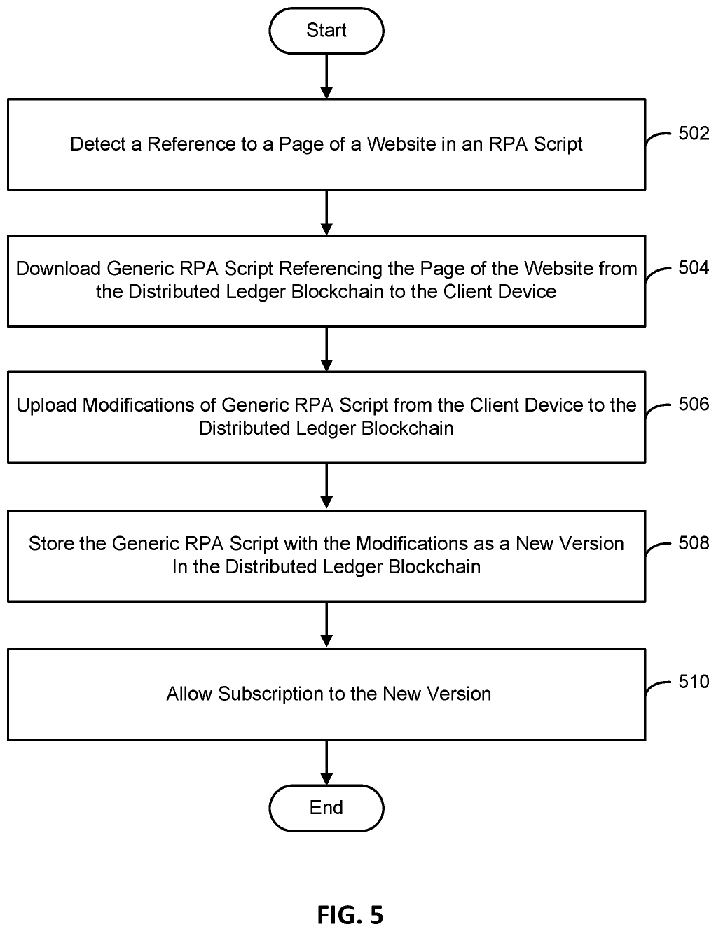

FIG. 5 shows a flowchart of an exemplary method in accordance with aspects of the present invention. Steps of the method may be carried out in the environment of FIG. 2 and are described with reference to elements depicted in FIG. 2 and FIG. 4. In particular, the flowchart of FIG. 5 shows an exemplary method for automatically generating RPA scripts by mass collaboration of RPA development on a distributed ledger blockchain, in accordance with aspects of the present invention.

At step 502, the system detects a reference to a page of a website in an RPA script. For example, an RPA developer, who opted in to use the exemplary modules of the system in an IDE executing on a client device, can write in an RPA script a reference to a root page of a website. As the IDE executing on the client device incrementally sends the RPA script to the system, the system detects in the RPA script a reference to the root page of the website. In embodiments, and as described with respect to FIG. 2, automatic RPA development module 210 detects in the developer's IDE an RPA script that references the page of the website and includes in embodiments RPA parser module 212 that parses the RPA script to identify URLs in the RPA code.

At step 504, the system downloads a generic RPA script referencing the page of the website from the distributed ledger blockchain to a client device. For example, the system may find generic RPA scripts that interact with the root page of the website stored in the distributed ledger blockchain and may download one or more of the generic RPA scripts to the developer's IDE on the client device. The developer may select, use and/or modify the generic RPA scripts presented in the IDE. In embodiments, and as described with respect to FIG. 2, RPA script downloader and uploader module 218 downloads the generic RPA script 228 referencing the page of the website from the distributed ledger blockchain 226 to user device 238.

At step 506, the system uploads modifications of the generic RPA script from the client device to the distributed ledger blockchain. For example, the generic RPA script downloaded to the client device at step 504 can be modified by the developer in the IDE on the client device. In embodiments, and as described with respect to FIG. 2, RPA script downloader and uploader module 218 uploads modifications of generic RPA scripts from the developer's IDE on the client device to the distributed ledger blockchain. The system parses the modifications to the generic RPA script in embodiments retaining functional information without business information as described at step 404 with respect to FIG. 4.

At step 508, the system stores the generic RPA script with the modifications as a new version in the distributed ledger blockchain. In embodiments, and as described with respect to FIG. 2, automatic RPA development module 210 records the modified RPA script as a new version in the distributed ledger blockchain. At step 510, the system allows subscriptions to the new version of the modified RPA scripts. RPA developers, who opt in to use the exemplary modules of the system in an IDE executing on a client device, have access to the new version in the distributed ledger blockchain.

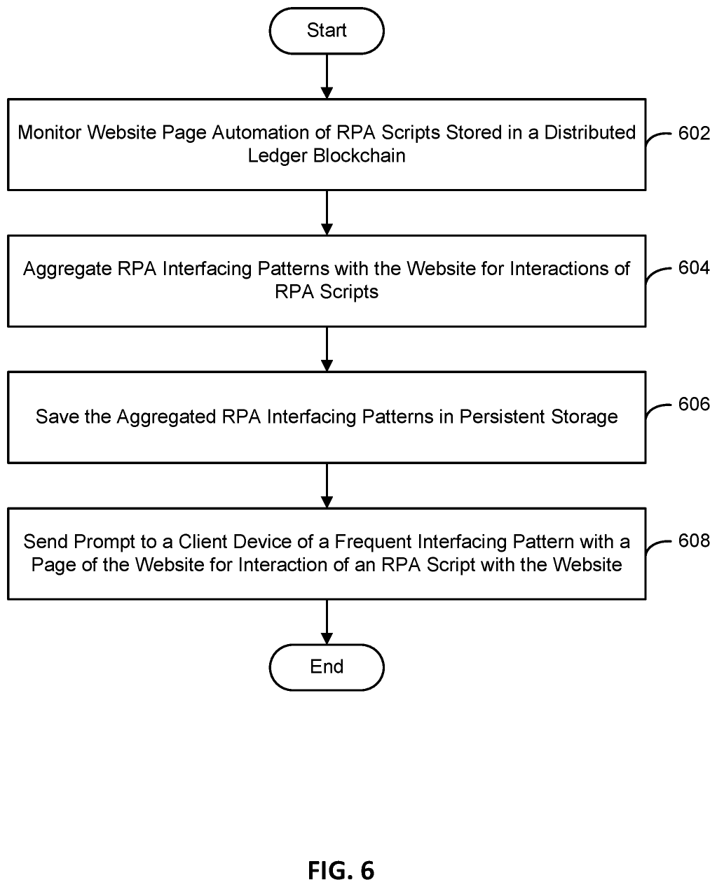

FIG. 6 shows a flowchart of an exemplary method in accordance with aspects of the present invention. Steps of the method may be carried out in the environment of FIG. 2 and are described with reference to elements depicted in FIG. 2. In particular, the flowchart of FIG. 6 shows an exemplary method for informing a developer on a client device of a frequent interfacing pattern with a page of the website for interaction of an RPA script with the website.

At step 602, the system monitors website page automation of RPA scripts in the distributed ledger blockchain. For example, the system captures the success of automation of the pages by success code or input of user review as the pages of the website are successfully automated in the RPA script. The RPA script may be instrumented in embodiments to provide the execution pathway and contextual information of the bot, for example, to the bot monitor module 216 as described with respect to FIG. 2. Accordingly, the bot monitor module 216 receives the execution pathway and contextual information in embodiments as the website pages are successfully automated. In embodiments, and as described with respect to FIG. 2, bot monitor module 216 monitors website page automation of RPA scripts in the distributed ledger blockchain.

At step 604, the system aggregates RPA interfacing patterns with the website for interactions of the RPA scripts with pages of the website. For example, the system obtains execution information of bots including the execution pathways of the bots through pages of a website or multiple websites. The system processes transactions in aggregate to understand the pathway to implementation of the RPA scripts with pages of the website. In embodiments, and as described with respect to FIG. 2, bots analysis module 220 aggregates RPA interfacing patterns with the website for interactions of the RPA scripts with pages of the website. At step 606, the system saves the aggregated RPA interfacing patterns in persistent storage. In embodiments, and as described with respect to FIG. 2, bots analysis module 220 saves the aggregated RPA interfacing patterns in RPA analytics database 232.

At step 608, the system sends a prompt to a client device of a frequent interfacing pattern with a page of the website for interaction of an RPA script with the website. For example, an RPA developer, who opted in to use the exemplary modules of the system in an IDE executing on a client device, can begin writing an RPA script that interacts with a page of the website. As the IDE executing on the client device incrementally sends a generic RPA script to the system, the system can analyze the generic RPA script interfacing pattern with the page of the website and find a frequent interfacing pattern stored in the RPA analytics database. The system can send a prompt to the client device to present in the IDE of the developer the frequent interfacing pattern with the page of the website. In embodiments, and as described with respect to FIG. 2, bots analysis module 220 sends the prompt to the client device of the frequent interfacing pattern with the page of the website for interaction of the RPA script with the website. The developer can update the RPA script to interact with the page of the website using the frequent interfacing pattern and the system can save the generic RPA script using the frequent interfacing pattern in the distributed ledger blockchain.

In this way, embodiments of the present disclosure may monitor website page automation of RPA scripts in the distributed ledger blockchain and begin processing transactions in aggregate to understand the pathway to implementation of the RPA script with pages of the website. Furthermore, embodiments of the present disclosure can aggregate executions tracked on client devices to detect failure of an RPA script interacting with a page of a website that trigger a blockchain query for implementation pathway or process flow updates that may be used to modify the RPA script for successful RPA integration with the page.

Those skilled in the art should appreciate that the methods, systems, and computer program products described herein can be enhanced to provide a distributed ledger blockchain with geographical localization of generic RPA scripts and RPA analytics of interaction patterns. For example, the system can identify in embodiments the geographical location of the client device used by a developer and automatically compare it to the location of the client devices used by other developers. The system can accordingly standardize the RPA scripts and interaction patterns based on the geographical location of the user.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
generating, by a processor set and from a robotic process automation (RPA) script, a generic RPA script retaining functional information of the RPA script without business data of the RPA script;
recording, by the processor set, the generic RPA script in a distributed ledger blockchain;
obtaining, by the processor set, contextual information of the generic RPA script including uniform resource locator, query parameters, and post parameters; and
recording, by the processor set, the contextual information of the generic RPA script in the distributed ledger blockchain.

2. The method of claim 1, further comprising receiving, by the processor set, the RPA script from a client device.

3. The method of claim 1, further comprising monitoring, by the processor set, website page automation of the RPA script.

4. The method of claim 1, further comprising determining, by the processor set, the RPA script is functional based on a success code of website page automation of the RPA script.

5. The method of claim 1, wherein the generating the generic RPA script comprises removing business data from the RPA script.

6. The method of claim 1, wherein the generating the generic RPA script comprises instrumenting the generic RPA script to collect execution and the contextual information for analysis.

7. The method of claim 1, further comprising:
allowing, by the processor set, subscription to the generic RPA script in the distributed ledger blockchain by users automating interactions with a website; and
downloading, by the processor set, the generic RPA script from the distributed ledger blockchain to a client device.

8. The method of claim 7, further comprising uploading, by the processor set, the generic RPA script with modifications to the distributed ledger blockchain from the client device.

9. The method of claim 8, further comprising recording, by the processor set, the generic RPA script with the modifications as a new version in the distributed ledger blockchain.

10. The method of claim 1, further comprising:
monitoring website page automation of a plurality of generic RPA scripts in the distributed ledger blockchain;
aggregating generic RPA interfacing patterns with a page of a website for interactions of the plurality of generic RPA scripts with the website; and
saving the aggregated generic RPA interfacing patterns with the page of the website in persistent storage.

11. A computer program product comprising one or more computer readable storage media having program instructions collectively stored on the one or more computer readable storage media, the program instructions executable to:
download a generic RPA script referencing a page of a website from a distributed ledger blockchain to a client device;
upload modifications of the generic RPA script from the client device to the distributed ledger blockchain; and
store the generic RPA script with the modifications as a new version in the distributed ledger blockchain.

12. The computer program product of claim 11, wherein the program instructions are further executable to detect in an RPA script a reference to the page of the website.

13. The computer program product of claim 11, wherein the program instructions are further executable to allow subscription to the new version of the generic RPA script with the modifications.

14. The computer program product of claim 11, wherein the program instructions are further executable to remove business data from the modifications of the generic RPA script.

15. The computer program product of claim 11, wherein the program instructions are further executable to instrument the modifications of the generic RPA script to collect execution and the contextual information for analysis.

16. The computer program product of claim 11, wherein the program instructions are further executable to determine the generic RPA script with the modifications is functional.

17. A system comprising:
a processor, a computer readable memory, one or more computer readable storage media, and program instructions collectively stored on the one or more computer readable storage media, the program instructions executable to:
monitor website page automation of a plurality of generic RPA scripts in a distributed ledger blockchain;
aggregate RPA interfacing patterns with a page of a website for interactions of the plurality of generic RPA scripts with the website;
save the aggregated generic RPA interfacing patterns with the page of the website in persistent storage; and
send a prompt to a client device of a frequent interfacing pattern with the page of the website for interaction with the website.

18. The system of claim 17, wherein the program instructions are further executable to receive an RPA script interacting with the page of the website from the client device.

19. The system of claim 17, wherein the program instructions are further executable to receive from the client device the RPA script updated to interact with the page of the website using the frequent interfacing pattern.

20. The system of claim 17, wherein the program instructions are further executable to record in the distributed ledger blockchain a generic RPA script interacting with the page of the website using the frequent interfacing pattern.
